(19) United States
(12) Patent Application Publication
(10) Pub. No.: US 2013/0139949 A1
(43) Pub. Date: Jun. 6, 2013

(54) METHOD FOR ADHERING WORKS AND WORK ADHERING APPARATUS

(71) Applicant: Fujikoshi Machinery Corp., Nagano-shi (JP)

(72) Inventors: Atsushi OBUSE, Nagano-shi (JP); Mitsuko TERASAWA, Nagano-shi (JP)

(73) Assignee: FUJIKOSHI MACHINERY CORP., Nagano-shi (JP)

(21) Appl. No.: 13/672,969

(22) Filed: Nov. 9, 2012

(30) Foreign Application Priority Data
Dec. 6, 2011 (JP) 2011-266976

(51) Int. Cl. B30B 15/34

(52) U.S. Cl. CPC B30B 15/34
USPC 156/64; 156/580; 156/583.1; 156/499; 156/378; 156/60; 156/322

(57) ABSTRACT

The method for adhering works is capable of polishing the works so as to have the same thickness. The method for adhering works is performed in a work adhering apparatus comprising: a press table; and a plurality of pressing heads being provided above the press table and capable of independently moving close to and away from the press table. The press table and the pressing heads press and adhere the works onto a plate with an adhesive agent. Each of the pressing heads presses and adheres the one work onto the plate at a constant pressure.

### CROSS-REFERENCE TO RELATED APPLICATION

This application is based upon and claims the benefit of priority of the prior Japanese Patent Application No. P2011-266976, filed on Dec. 6, 2011 and the entire contents of which are incorporated herein by reference.

### FIELD

The present invention relates to a method for adhering works on a plate, which will be set in and polished by a polishing apparatus, and a work adhering apparatus performing said method.

### BACKGROUND

In case of polishing one side of works, e.g., silicon wafers, the prescribed number of works are adhered on a plate, the plate is set in a polishing apparatus in a state where surfaces of the works to be polished face a polishing cloth of a polishing plate, and the polishing plate is rotated, with supplying slurry, so as to polish the surfaces of the works.

A conventional technology for adhering a plurality of works onto a plate is disclosed in Japanese Laid-open Patent Publication No. 5-82493.

In this technology, a heating table including a heater is previously heated until reaching a prescribed temperature, and then the plate is mounted on the heating table so as to heat the plate.

Next, an adhesive agent is applied to prescribed parts of the plate, on which the works will be adhered.

The works are respectively mounted onto the prescribed parts where the adhesive agent has been melted.

Next, the plate, on which the works have been set with the adhesive agent, is mounted onto a press table, which is located adjacent to the heating table and which includes a cooling mechanism.

A pressing head, which is provided above the press table and capable of moving upward and downward, is moved downward so as to press the works and the plate between the pressing head and the press table, so that the works are pressed onto the plate and the adhesive agent is spread. Further, cooling water is supplied to the cooling mechanism of the press table so as to cool the plate and the adhesive agent, so that the adhesive agent is solidified and the works are adhered on the plate.

In the conventional technology disclosed in Japanese Laid-open Patent Publication No. 5-82493, the prescribed number of works are set on the one plate with the adhesive agent, and the works and the plate are pressed between the pressing head and the press table so as to adhere the works onto the plate at a time.

A pressing face of the pressing head is previously adjusted to become parallel to the press table.

However, the technology disclosed in Japanese Laid-open Patent Publication No. 5-82493 has following disadvantages.

Namely, thicknesses of the works to be polished will be non-constant in the preparatory stage. In this case, the works are simultaneously pressed onto the surface of the plate, by the pressing head, in a state where a clearance between the pressing face of the pressing head and the surface of the plate (the surface of the press table) is constant. In case of adhering the thick works, an amount of protruding the adhesive agent from the works is increased, so the works are adhered by thin layers of the adhesive agent. On the other hand, in case of adhering the thin works, an amount of protruding the adhesive agent is reduced, so the works are adhered by thick layers of the adhesive agent. If the works are polished, by a polishing apparatus, in the above described states, the problem of non-constant thickness of the polished works cannot be solved.

For example, in case of adhering sapphire substrates, on which nitride semiconductor layers (e.g., GaN) are formed, as the works, the sapphire substrates are thick, e.g., about 900 μm, and the thickness is highly reduced, by polishing, until reaching, for example, about 100 μm. In case that one sapphire substrate, which has a thickness of 900 μm, and another sapphire substrate, which has a thickness of 920 μm, are polished to reduce 800 μm, the thickness of the one sapphire substrate polished becomes 100 μm and the thickness of another sapphire substrate polished becomes 120 μm. Therefore, variation of thickness of the works cannot be solved, further the variation will be increased.

In case of adhering works which are produced by epitaxial-growing nitride semiconductor layers (e.g., GaN) on sapphire substrates, each of the works is constituted by two layers having different thermal expansion coefficients, so the works easily warp toward the sapphire substrate side. By pressing the sapphire substrates by the pressing head, the problem of the warpage can be eliminated. However, if thicknesses of the sapphire substrates are non-constant, degrees of eliminating the warpage are different for the sapphire substrates. Further, it is difficult to completely eliminate the warpage from thin sapphire substrates.

### SUMMARY

Accordingly, it is an object to provide a method for adhering works and a work adhering apparatus capable of solving the above described problems of the conventional technology. Namely, works adhered by the method and apparatus of the present invention will be polished so as to have the same thickness.

To achieve the object, the present invention has following structures.

Namely, the method of the present invention is performed in a work adhering apparatus comprising: a press table; and a plurality of pressing heads being provided above the press table and capable of independently moving close to and away from the press table,

the press table and the pressing heads press and adhere the works onto a plate with an adhesive agent, and

said method comprising the step of:

pressing the one work onto the plate at a constant pressure by each of the pressing heads and adhering the one work onto the plate.

Preferably, the method comprises the steps of:

conveying the plate, which has been heated at a prescribed temperature, to the press table, or heating the plate on the press table until reaching the prescribed temperature;

applying the adhesive agent to a prescribed part of the plate heated at the prescribed temperature;

mounting the works onto the heated and melted adhesive agent;

moving each of the pressing heads toward the press table so as to press the one work onto the plate, for a prescribed time, at the constant pressure;

adhering the works on the plate by cooling and solidifying the adhesive agent in the state where the works are pressed by the pressing heads; and

moving each of the pressing heads away from the press table so as to take out the plate, on which the works have been adhered, from the press table.

Another method is performed in a work adhering apparatus comprising: a press table including a heating mechanism and a cooling mechanism; and a plurality of pressing heads being provided above the press table and capable of independently moving close to and away from the press table,

the press table and the pressing heads press and adhere the works onto a plate with an adhesive agent, and

the method comprises the steps of:

conveying the plate, which has been heated at a prescribed temperature, to the press table, or heating the plate on the press table until reaching the prescribed temperature;

applying the adhesive agent to a prescribed part of the plate heated at the prescribed temperature;

mounting the works onto the heated and melted adhesive agent;

heating the pressing heads until reaching the prescribed temperature;

moving each of the pressing heads toward the press table so as to press the one work onto the plate, for a prescribed time, at the constant pressure;

adhering the works on the plate by cooling the press table and the plate with the cooling mechanism and solidifying the adhesive agent in the state where the works are pressed by the pressing heads; and

moving each of the pressing heads away from the press table so as to take out the plate, on which the works have been adhered, from the press table.

Preferably, in the step of adhering the works, temperatures of the pressing heads are detected, and

the pressing action of the pressing head is stopped after the temperature of the pressing head lower than the prescribed temperature is confirmed.

Preferably, the plate is previously heated on a heating table, which includes a heater and which is separated from the press table, and

the heated plate is conveyed onto the press table.

The pressing heads may be brought into contact with the press table so as to heat the pressing heads until reaching the prescribed temperature.

Each of the pressing heads may be heated, until reaching the prescribed temperature, by a built-in heater.

Each of the pressing heads is rotatable about a ball bearing, and

each of the pressing heads is rotated to follow the surface of the plate so as to press the work.

Sapphire substrates, on each of which a nitride semiconductor layer is formed, may be adhered onto the plate, as the works, in a state where the nitride semiconductor layers face the plate.

The work adhering apparatus of the present invention comprises:

a press table; and

a plurality of pressing heads being provided above the press table and capable of independently moving close to and away from the press table,

wherein the press table and the pressing heads press and adhere the works onto a plate with an adhesive agent, and

each of the pressing heads presses the one work onto the plate at a constant pressure.

Preferably, the pressing heads are connected to a common air supply source, so that the works can be pressed onto the plate at a constant pressure.

Preferably, the press table includes a heating mechanism and a cooling mechanism, and

the press table and the pressing heads are heated, the works are pressed onto the adhesive agent applied on the plate to spread the adhesive agent, then the press table and the plate are cooled, by the cooling mechanism, so as to solidify the adhesive agent and adhere the works on the plate.

Preferably, the work adhering apparatus further comprises a temperature detecting section for detecting temperatures of the pressing heads,

the temperature detecting section detects temperatures of the pressing heads while cooling the press table to solidify the adhesive agent, and

the pressing action of the pressing head is stopped after the temperature of the pressing head lower than a prescribed temperature is confirmed.

Preferably, the temperature detecting section detects a temperature of a part of each of the pressing heads located close to a pressing face for pressing the work.

Preferably, the pressing heads are brought into contact with the press table so as to heat the pressing heads until reaching the prescribed temperature.

Preferably, each of the pressing heads includes a heating mechanism and a cooling mechanism, so that each of the pressing heads can be heated and cooled by its own heating and cooling mechanisms.

Preferably, the work adhering apparatus further comprises a heating table including a heater, the heating table being separated from the press table, and

the plate is previously heated on the heating table, and then the heated plate is conveyed onto the press table.

Preferably, the cooling mechanism is embedded in a part of the press table, which is located close to the surface on which the plate is mounted.

Preferably, the work adhering apparatus further comprises a temperature detecting section for detecting temperatures of the plate, which has been mounted on the heating table, the press table and the heating table.

By employing the present invention, the pressing heads can independently press the works at the constant pressure. Even if thicknesses of the works are varied, surplus adhesive agent can be protruded from the works and thicknesses of the adhesive agent layers can be uniformed when the works are adhered. Therefore, the works can be polished so as to have the same thickness.

### BRIEF DESCRIPTION OF THE DRAWINGS

Embodiments of the present invention will now be described by way of examples and with reference to the accompanying drawings, in which:

FIG. 1 is a front view of a work adhering apparatus;

FIG. 2 is a partially cutaway view of a press table;

FIG. 3 is an explanation view of a plate;

FIG. 4 is a front view of a work adhering apparatus including one first stage and one second stage;

FIG. 5 is a sectional view of another example of a pressing head; and

FIG. 6 is a front view of a further embodiment of the work adhering apparatus.

### DETAILED DESCRIPTION OF THE EMBODIMENTS

Preferred embodiments of the present invention will now be described in detail with reference to the accompanying drawings.

The method of the present invention is performed in a work adhering apparatus comprising: a press table; and a plurality of pressing heads being provided above the press table and capable of independently moving close to and away from the press table. The press table and the pressing heads press and adhere the works onto a plate with an adhesive agent. The method is characterized in that each of the pressing heads presses and adheres the one work onto the plate at a constant pressure.

In the method, the plate, which has been previously heated until reaching a prescribed temperature, is conveyed onto the press table, or the plate is conveyed onto the press table and heated, until reaching the prescribed temperature, on the press table.

The adhesive agent is applied to prescribed parts of the plate heated at the prescribed temperature.

The works are mounted onto the heated and melted adhesive agent.

Each of the pressing heads is moved toward the press table so as to press the corresponding work onto the plate, for a prescribed time, at a constant pressure.

Next, the works are adhered on the plate by cooling and solidifying the adhesive agent in the state where the works are pressed by the pressing heads.

Then, each of the pressing heads is moved away from the press table so as to take out the plate, on which the works have been adhered, from the press table. By performing the above described steps, the work adhering operation is completed.

A work adhering apparatus for performing the method comprises: a press table; and a plurality of pressing heads being provided above the press table and capable of independently moving close to and away from the press table. The press table and the pressing heads press and adhere works onto a plate with an adhesive agent, and each of the pressing heads presses the one work onto the plate at a constant pressure. The work adhering apparatus will be explained later in detail.

In an embodiment of the present invention, a plurality of the works are adhered on the one plate, number of the pressing heads is equal to that of the works, and each of the pressing heads independently presses the corresponding work. The pressing heads respectively press the works, onto the plate, at the constant pressure, so that the works can be adhered on the plate. By independently pressing the works onto the plate, with the pressing heads, at the constant pressure, surplus adhesive agent can be protruded from the works and thicknesses of the adhesive agent layers can be uniformed when the works are adhered. Namely, even if thicknesses of the works are varied, the thicknesses of the adhesive agent layers for the works can be uniformed.

However, if thicknesses of the works are varied, heights of the adhered works, from the plate, must be varied.

But, in case that the plate on which the works have been adhered is mounted on a polishing plate of a polishing apparatus, in a state where the works face a polishing cloth, so as to polish the works, the higher works are polished more. Therefore, finally the polished works can be level with each other.

In case of adhering warped works, e.g., sapphire substrates, too, the sapphire substrates are respectively pressed, by the pressing heads, at the constant pressure, so that their warpage can be equally corrected. By polishing the sapphire substrates in the corrected state, even if thicknesses of the sapphire substrates are varied, amounts of polishing the sapphire substrates are different as described above. Therefore, finally thicknesses of the sapphire substrates and correcting warpage thereof can be uniformed.

By the way, various types of adhesive agents are known. Generally, wax, which is melted by heating and solidified by cooling, is used as the adhesive agent.

In case of using the wax as the adhesive agent, a step of heating the wax and a step of cooling the wax are required.

Heating and cooling the wax (adhesive agent) can be performed as described in Japanese Laid-open Patent Publication No. 5-82493.

Namely, a heating table including a heater is heated until reaching a prescribed temperature, and then the plate is conveyed onto the heating table so as to heat the plate.

Next, the adhesive agent is applied to the prescribed parts of the heated plate, on which the work will be adhered.

The works are respectively mounted onto the heated and melted adhesive agent.

The plate, on which the works have been mounted, is conveyed onto the press table, which is located adjacent to the heating table and which includes a cooling mechanism.

Each of the pressing heads, which is provided above the press table and capable of independently moving upward and downward, is moved toward the press table so as to press the corresponding one work onto the plate between the pressing head and the press table. By this action, the adhesive agent is spread. Simultaneously, cooling water is supplied to the cooling mechanism of the press table so as to cool the plate and the adhesive agent. Therefore, the adhesive agent is solidified, and the works can be adhered on the plate.

In the above described method, when the plate, which has been heated on the heating table, is conveyed onto the press table, the heat of the plate is conducted to the press table. When the pressing heads contact the works, the heat is conducted to the pressing heads too. Further, the cooling water is supplied to the press table in this state, so that the temperature of the adhesive agent is lowered. Thus, in case of using some adhesive agents, there are possibilities that the adhesive agent solidifies before being spread and that thicknesses of the adhesive agent layers are varied.

The method for adhering works and the work adhering apparatus, which are capable of solving the above described problems, will be explained in detail.

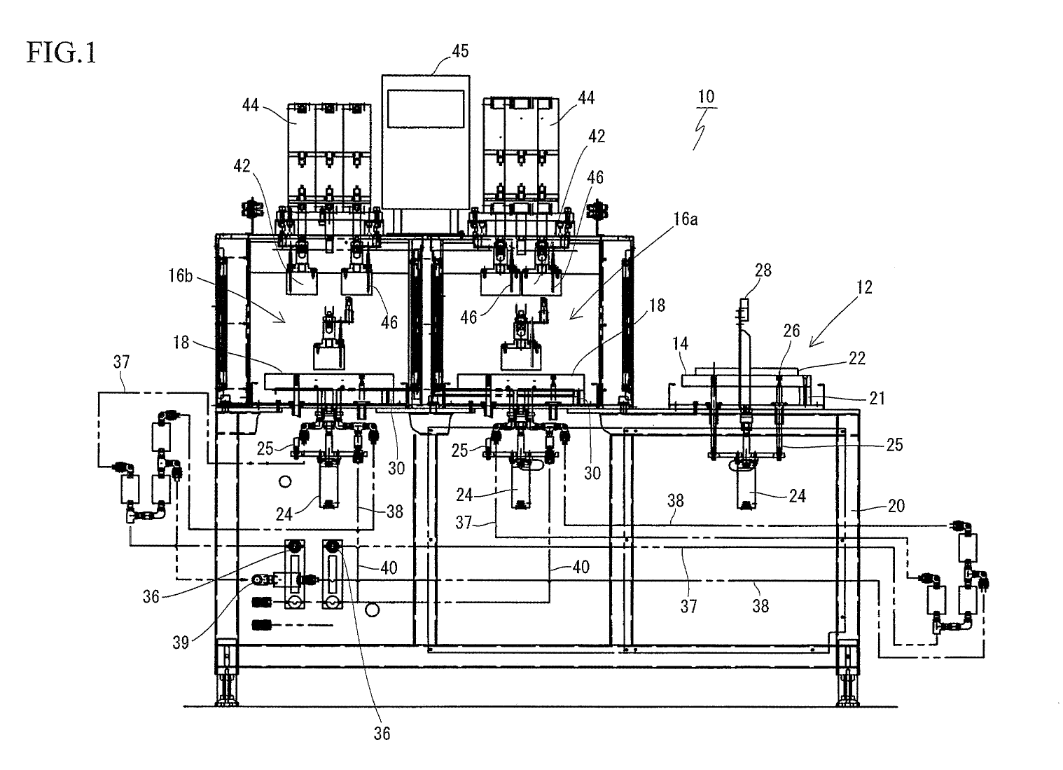

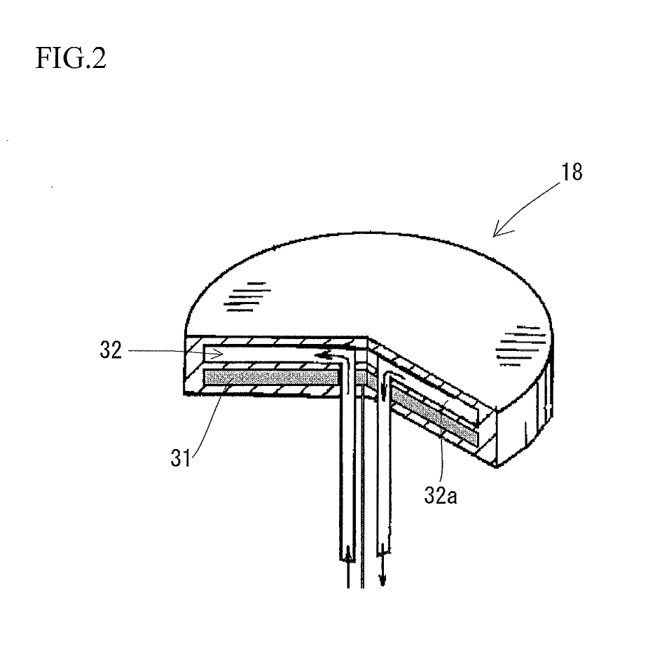

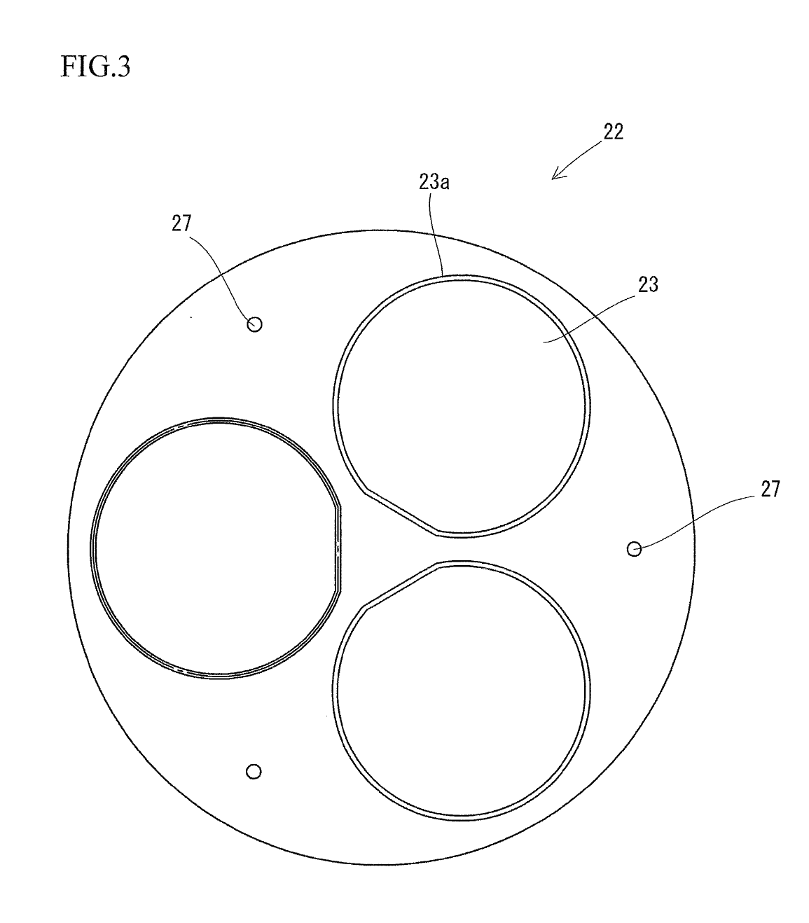

FIG. 1 is a front view of the work adhering apparatus, FIG. 2 is a partially cutaway view of a press table 18, and FIG. 3 is a plan view of a plate 22.

In FIG. 1, a first stage 12 includes a heating table 14, and second stages 16a and 16b, which respectively include the press tables 18, are located adjacent to the first stage 12.

The heating table 14 includes a first heater (not shown) and is horizontally fixed, on a frame 20, by supporting members 21. The plate 22, onto which works 23 will be adhered, is conveyed onto the heating table 14.

A positioning cylinder 24 is provided under the heating table 14 and has three positioning pins 25 (two positioning pins are shown in FIG. 1), which are connected to a rod. The positioning pins 25 are vertically penetrated through through-holes 26 formed in the heating table 14 and can be projected from and retracted into the upper surface of the heating table 14. The plate 22 has three through-holes 27, which respectively correspond to the positioning pins 25 (see FIG. 3).

In the present embodiment, the plate 22 is manually set on the heating table 14. The plate 22 is set on the heating table 14 in a state where the positioning pins 25 are inserted in the through-holes 27, so that the plate 22 is correctly positioned on the heating table 14. Marks for indicating the adhering positions of the works 23 are formed in the plate 22. In the present embodiment, as shown in FIG. 3, circular grooves 23a, each of which is formed along the outer edges of the works 23, are formed as the marks. By putting the works 23 into the areas surrounded by the circular grooves 23a, the works 23 can be correctly positioned on the plate 22. When the works 23 are adhered, surplus adhesive agent protruded from the works 23 flows into the circular grooves 23a.

A temperature detecting section (not shown) for detecting a temperature of the heating table 14 heated by the first heater is provided to the heating table 14. The first heater is controlled, by a control section 45, so as to maintain the temperature detected by the temperature detecting section in a predetermined temperature range.

An infrared temperature sensor (a temperature detecting section) 28 is provided above the heating table 14. The infrared temperature sensor 28 detects a temperature of the surface of the plate 22 set on the heating table 14.

The press tables 18 of the second stages 16a and 16b are horizontally supported, on the frame 20, by supporting members 30. As shown in FIG. 2, each of the press tables 18 includes a second heater 31 and a cooling mechanism 32 to which cooling water is supplied. A jacket 32a, through which the cooling water is circulated, is located closer to the surface of the press table 18 than the second heater 31, so that the plate 22 on the press table 18 can be cooled rapidly.

A circuit of the cooling mechanism for circulating the cooling water is shown in FIG. 1. The cooling water whose temperature has been adjusted is supplied to a water tank (not shown) through connection ports 36 and stored in the water tank. A symbol 37 stands for an outward circuit of the cooling water; a symbol 38 stands for a return circuit thereof. The cooling water passes through the jackets 32a of the press tables 18 and is discharged from a discharge port 39. Note that, the cooling water in the circuit can be drained through a drain circuit 40 by opening a valve (not shown).

The positioning mechanisms, each of which includes the positioning cylinder 24 and the three positioning pins 25, are respectively provided to the second stages 16a and 16b so as to correctly position the plate 22 conveyed from the heating table 14, as well as the first stage 12.

Each of the press tables 18 includes a temperature detecting section (not shown) for detecting a temperature of the press table 18 heated by the second heater 31. The second heater 31 is controlled, by the control section 45, so as to maintain the temperature detected by the temperature detecting section in a predetermined temperature range.

A plurality of pressing heads 42 are provided above each of the press table 18, and they can be independently moved upward and downward (moved close to and away from the press table 18). Three pressing heads 42 are provided for the second stage 16a; five pressing heads 42 are provided for the second stage 16b (three of them are shown in FIG. 1). In the second stage 16a, the three works 23, which are relatively large, are adhered on the one plate 22. On the other hand, in the second stage 16b, the five works 23, which are relatively small, are adhered on the one plate 22.

The pressing heads 42 are respectively attached to lower ends of rods of air cylinder units (driving sections) 44, which are supported by the frame 20, and moved upward and downward. Each of the pressing heads 42 may be fixed to the lower end of the rod in a state where a pressing face is arranged parallel to the press table 18. Further, each of the pressing heads 42 may be rotatable about a ball bearing (not shown), which is provided to the lower end of the rod, so as to follow inclination of the surface of the press table 18 (the surface of the work 23 to be pressed). Note that, for example, a sheet-shaped tactile sensor or pressure sensitive paper (not shown), which detects pressure distribution of a pressing force, may be used so as to adjust an inclination angle of the pressing head 42, so that the pressing face of the pressing head 42 can become parallel to the surface of the press table 18.

Each of the pressing heads 42 is heated on the heating table 14, the adhesive agent is applied to prescribed parts of the plate 22 heated at the prescribed temperature, the works 23 are mounted onto the heated and melted adhesive agent, and then the works 23 on the plate 22 are pressed between the pressing head 42 and the press table 18 at a constant pressure (pressing force).

To press the works 23, by the pressing heads 42, at the constant pressure, upper chambers of the air cylinder units 44 are connected to a common air pressure source (not shown). Further, the upper chambers of the air cylinder units 44 may be connected to separated air pressure sources via a regulator (not shown), so that the same pressure is produced by the regulator.

Each of the pressing heads 42 includes a temperature detecting section 46, e.g., thermo couple. The lower end of the thermo couple 46 reaches the lower part of the pressing head 42 so as to detect a temperature of the lower part of the pressing head 42 (the part close to the pressing face for pressing the work 23).

The work adhering apparatus 10 has the above described structure.

The method of the present embodiment performed in the work adhering apparatus 10 will be explained.

In the first stage 12, the heating table 14 has been previously heated, by the first heater, until reaching the prescribed temperature (e.g., 120-125° C.). The temperature of the heating table 14 is detected by the temperature detecting section and maintained in the prescribed temperature range.

Next, the plate 22 is positioned on the heating table 14, which has been heated at the prescribed temperature, by the positioning pins 25. In the present embodiment, the plate 22 is manually conveyed and set onto the heating table 14. The plate 22 is heated, by the heat conducted from the heating table 14, until reaching a prescribed temperature (e.g., 110° C.). The temperature of the plate 22 can be detected by the infrared temperature sensor 28.

When the temperature of the plate 22 reaches the prescribed temperature, a prescribed amount of the adhesive agent is applied to the prescribed parts (work adhering parts) of the plate 22. The adhesive agent may be manually applied or automatically applied by a supplying device. Since the plate 22 has been previously heated at the prescribed temperature, the applied adhesive agent is melted.

In each of the second stages 16a and 16b too, the second heater 31 is turned on so as to heat the press table 18 until reaching the prescribed temperature (e.g., 120-125° C.). The temperature of the press table 18 is detected by the temperature detecting section and maintained in the prescribed temperature range. Note that, supplying the cooling water to the cooling mechanism 32 has been stopped, so the cooling water is also heated. By heating the cooling water, the heat is conducted from the cooling water too, so that the press table 18 can be uniformly heated.

In this operation, each of the pressing heads 42 is moved downward until contacting the press table 18 so as to heat the pressing head 42, by the heat conduction, until reaching a prescribed temperature (e.g., 110° C.). The temperature of the pressing head 42 can be detected by the thermo couple 46.

When temperatures of the pressing heads 42 reach the prescribed temperature, the pressing heads 42 are upwardly moved away from the press table 18, and then the plate 22, which has been heated on the heating table 14 and on which the works 23 have been mounted, is conveyed and set onto the press table 18.

Next, the press heads 42 are downwardly moved toward the press table 18, and the plate 22 and the work 23 are pressed between the pressing heads 42, which have been heated at the prescribed temperature, and the press table for a prescribed time (e.g., one minute). Since the works 23 are pressed by the pressing heads 42 and the press table 18, both of which are at the prescribed temperature, the adhesive agent is sufficiently spread with the uniform thickness. Especially, in the present embodiment, the pressing heads 42 are independently press the works 23 at the constant pressure as described above. Even if the thicknesses of the works 23 are varied, the surplus adhesive agent is protruded, from the works 23, by pressing the works 23. Therefore, thicknesses of the adhesive agent layers can be uniformed.

As described above, even if the thicknesses of the works 23 are varied, the works 23 can be adhered by the adhesive agent whose layer thicknesses are uniformed. Therefore, as described above, the works can be polished so as to have the same thickness. Note that, in case that each of the pressing heads 42 is rotatable about the ball bearing so as to follow the inclination of the surface of the press table 18 (the surfaces of the works 23 to be pressed), even if the works 23 are formed into tapered-shapes and have different thicknesses, the works can be adhered, with the adhesive agent whose layer thicknesses are uniformed, by making the lower surfaces of the works 23 parallel to the surface of the plate 22, so that the works 23 can be polished uniformly.

After the pressing heads 42 press the works 23 for the prescribed time, the second heater 31 is turned off, and the cooling water is supplied to the cooling mechanism 32 so as to cool the press table 18. Further, the plate 22 and the pressing heads 42 are cooled by heat conduction. By the cooling step, the adhesive agent is solidified and the works 23 are adhered on the plate 22.

In the cooling step, the temperatures of the pressing heads 42 are detected by the thermo couples 46. When the detected temperature of each of the pressing heads 42 is reduced to a prescribed temperature (e.g., 35° C.), the pressing heads 42 are moved upward so as to take out the plate 22, on which the works 23 have been completely adhered, from the press table 18.

Pressing the works 23 by the pressing heads 42 may be controlled on the basis of the pressing time only. However, by detecting the temperatures of the pressing heads 42 and completing the pressing step when the temperatures of the pressing heads 42 is reduced to the prescribed temperature as described above, the adhesive agent can be securely solidified. Namely, the pressing action by the pressing heads 42 is stopped when the temperature of the pressing head 42 being farthest away from the table 18 is reduced to the prescribed temperature, so that the adhesive agent can be securely solidified.

Note that, the prescribed temperatures of the heating table 14, the plate 22, the press table 18 and the pressing heads 42 are not limited to the above described examples. They may be optionally selected according to types of the adhesive agent, etc.

In the above described embodiment, applying the adhesive agent and mounting the works 23 onto the adhesive agent are performed on the heating table 14. However, in some cases, only the plate 22 may be heated on the heating table 14, and applying the adhesive agent and mounting the works 23 may be performed on the press table 18 after setting the heated plate 22 on the press table 18.

In the present embodiment, the works are not limited to, for example, silicon wafers. For example, sapphire substrates on which nitride semiconductor (e.g., GaN) layers are formed, SiC substrates, etc. can be suitably adhered, as the works.

In case that the works are sapphire substrates on which nitride semiconductor (e.g., GaN) layers are epitaxial-grown, each of the works is constituted by two layers having different thermal expansion coefficients, so the works easily warp. Thus, in the present embodiment, the works are pressed between the plate 22 and the pressing heads 42, both of which are heated at the prescribed temperatures, for the prescribed time, so that the works are pressed, in the state where the adhesive agent is melted, until the warpage is corrected. Then, the cooling step is performed. By pressing the works with the pressing heads 42 until the detected temperatures of the pressing heads 42 are reduced to the prescribed temperature as described above, the adhesive agent can be securely solidified and reoccurrence of the warpage can be prevented. Therefore, the works can be highly flatly adhered with the adhesive agent whose layer thicknesses are uniformed. Note that, in case of polishing the sapphire substrates, the sapphire substrates should be adhered on the plate 22 in a state where the nitride semiconductor layers should face the plate 22.

Note that, in the above described embodiment, the two second stages 16a and 16b are provided in the apparatus 10. Number of the second stage may be one, three or more. Number of the pressing heads 42 of each stage is not limited, either. Conveying the plate 22 in the stage or between the stages may be automatically performed by a known conveying device.

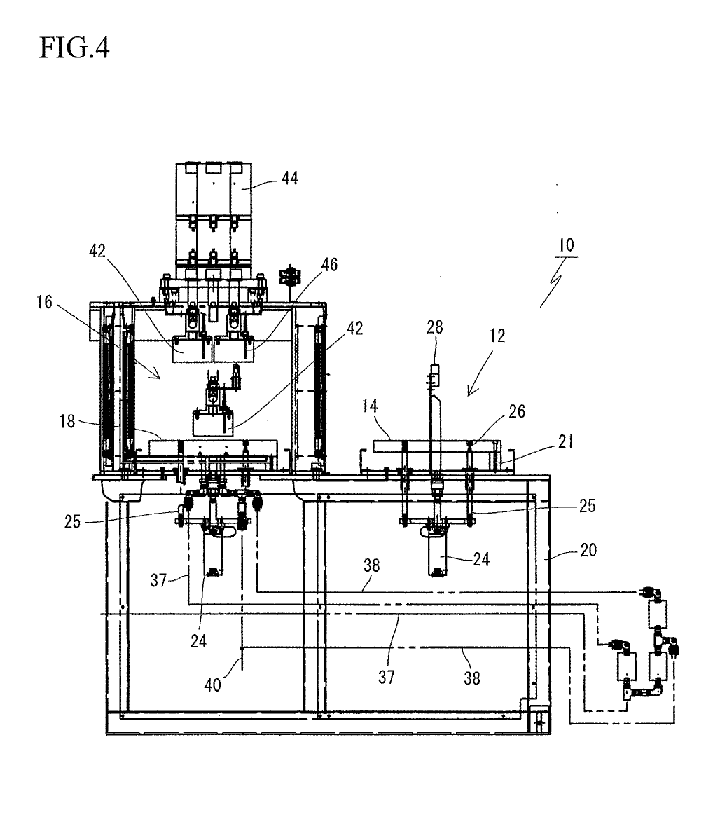

In an embodiment shown in FIG. 4, the one first stage 12 and the one second stage 16 are provided. Note that, the structural elements explained in the embodiment shown in FIG. 1 are assigned the same symbols and explanation will be omitted.

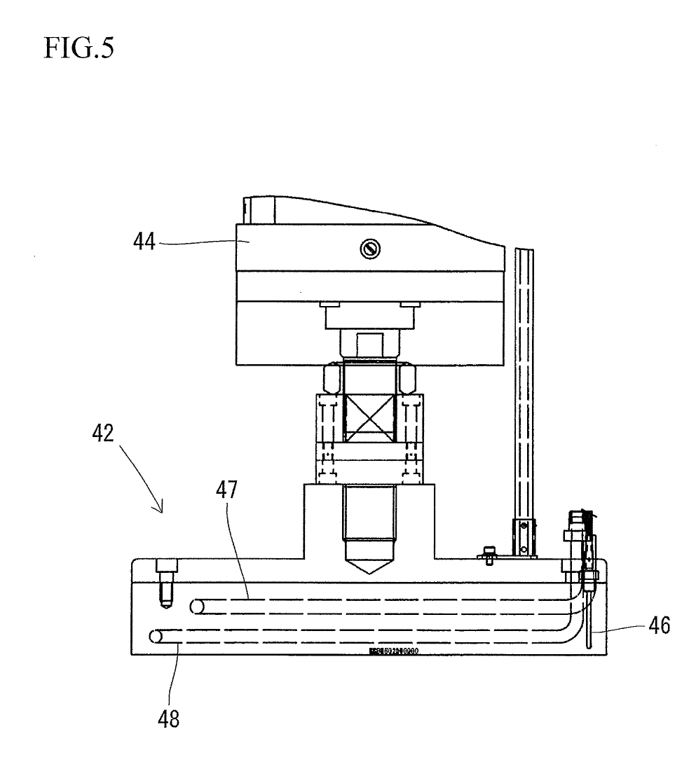

In the above described embodiments, each of the pressing heads 42 may be changed to an example shown in FIG. 5. FIG. 5 is a sectional view of the pressing head 42.

In the example shown in FIG. 5, the pressing head 42 includes a third heater 47 and a cooling mechanism 48. The third heater 47 is electrically connected to an electric power source (not shown) by a flexible cable (not shown), and the cooling mechanism 48 is connected to a water supply source (not shown) by a flexible tube (not shown).

In this example, each of the pressing heads 42 can be directly heated by the third heater 47, so that heating the pressing heads 42 can be performed smoothly. When the adhesive agent is solidified, the third heater 47 is turned off and the cooling water is supplied to the cooling mechanism 48, so that the pressing head 42 can be cooled more smoothly. Therefore, a tact time of adhering the works can be shortened. These actions are controlled by the control section 45.

Note that, each of the pressing heads 42 may include the third heater 47 only. The cooling mechanism 48 may be omitted.

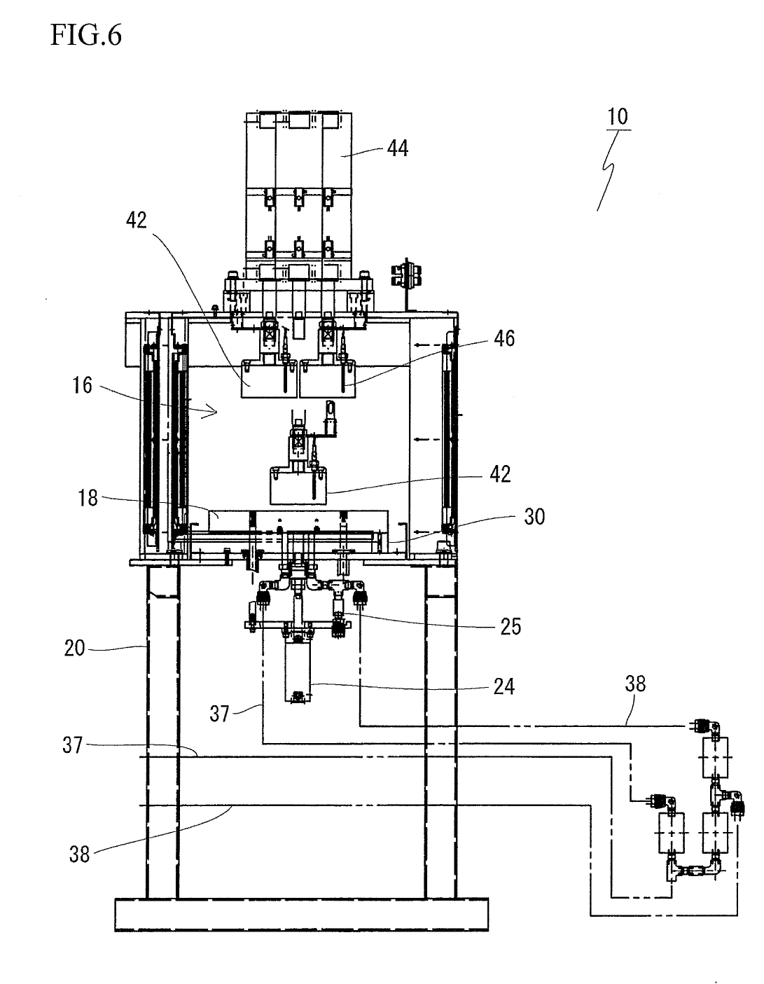

FIG. 6 is a front view of a further embodiment of the work adhering apparatus 10 of the present invention. Note that, the structural elements explained in the embodiment shown in FIG. 1 are assigned the same symbols and explanation will be omitted.

In the present embodiment, the first stage 12 is omitted, and only the second stage 16 is provided in the apparatus 10. The heater 31 and the cooling mechanism 32 are included in the press table 18 of the second stage 16, as well as the example shown in FIG. 2. All steps from heating the plate 22 to adhering the works 23 are performed on the press table 18.

The method performed in the work adhering apparatus 10 shown in FIG. 6 will be explained.

Firstly, the heater 31 of the press table 18 is turned on, and the press table 18 is heated until reaching the prescribed temperature (e.g., 120-125° C.).

The pressing heads 42 are moved downward until contacting the press table 18, and then the pressing heads 42 are heated, by the heat from the press table 18, until reaching the prescribed temperature (e.g., 110° C.).

When the temperatures of the pressing heads 42 are increased to the prescribed temperature, the pressing heads 42 are moved upward so as to open the press table 18.

Next, the plate 22 is correctly positioned on the press table 18, and the plate 22 is heated, by the heat from the press table 18, until reaching the prescribed temperature (e.g., 110° C.). Preferably, the temperature of the plate 22 is detected by an infrared temperature sensor (not shown).

When the temperature of the plate 22 reaches the prescribed temperature, a prescribed amount of the adhesive agent is applied to the prescribed parts of the plate 22 and melted.

Upon melting the adhesive agent, the works 23 are mounted on the adhesive agent.

Next, the press heads 42 are downwardly moved toward the press table 18, and the plate 22 and the works 23 are pressed between the pressing heads 42, which have been heated at the prescribed temperature, and the press table 18 for the prescribed time (e.g., one minute). Since the works 23 are pressed by the pressing heads 42 and the press table 18, both of which are heated at the prescribed temperature, the adhesive agent is sufficiently spread with the uniform layer thickness. In the present embodiment too, the pressing heads 42 are independently press the works 23 at the constant pressure as well. Even if the thicknesses of the works 23 are varied, the surplus adhesive agent is protruded, from the works 23, by pressing the works 23. Therefore, thicknesses of the adhesive agent layers can be uniformed.

As described above, even if the thicknesses of the works 23 are varied, the works 23 can be adhered by the adhesive agent whose layer thicknesses are uniformed. Therefore, as described above, the works can be polished and have the same thickness.

After the pressing heads 42 press the works 23 for the prescribed time, the second heater 31 is turned off, and the cooling water is supplied to the cooling mechanism 32 so as to cool the press table 18. Further, the plate 22 and the pressing heads 42 are cooled by heat conduction. By the cooling step, the adhesive agent is solidified and the works 23 are adhered on the plate 22.

In the cooling step, the temperatures of the pressing heads 42 are detected by the thermo couples 46. When the detected temperature of each of the pressing heads 42 is reduced to a prescribed temperature (e.g., 35° C.), the pressing heads 42 are moved upward so as to take out the plate 22, on which the works 23 have been completely adhered, from the press table 18.

Pressing the works 23 by the pressing heads 42 may be controlled on the basis of the pressing time only. However, by detecting the temperatures of the pressing heads 42 and completing the pressing step when the temperatures of the pressing heads 42 is reduced to the prescribed temperature as described above, the adhesive agent can be securely solidified. Namely, the pressing action by the pressing heads 42 is stopped when the temperature of the pressing head 42 being farthest away from the table 18 is reduced to the prescribed temperature, so that the adhesive agent can be securely solidified.

In the present embodiment too, each of the pressing heads 42 may include the heater 47 and the cooling mechanism 48 as well as the example shown in FIG. 5. In this case too, each of the pressing heads 42 can be directly heated by the third heater 47, so heating the pressing heads 42 can be performed smoothly. When the adhesive agent is solidified, the third heater 47 is turned off and the cooling water is supplied to the cooling mechanism 48, so that the pressing head 42 can be cooled more smoothly. Therefore, the tact time of adhering the works can be shortened.

In case of cooling each of the pressing heads 42, completing the pressing operation may be determined on the basis of the temperature of the plate 22 without detecting the temperatures of the pressing heads 42.

Note that, in this case too, each of the pressing heads 42 may include only the third heater, and the cooling mechanism may be omitted.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention has been described in detail, it should be understood that the various changes, substitutions, and alternations could be made hereto without departing from the spirit and scope of the invention.

What is claimed is:

1. A method for adhering works in a work adhering apparatus comprising:
a press table; and
a plurality of pressing heads being provided above the press table and capable of independently moving close to and away from the press table,
wherein the press table and the pressing heads press and adhere the works onto a plate with an adhesive agent,
said method comprising the step of:
pressing the one work onto the plate at a constant pressure by each of the pressing heads and adhering the one work onto the plate.

2. The method according to claim 1,
comprising the steps of:
conveying the plate, which has been heated at a prescribed temperature, to the press table, or heating the plate on the press table until reaching the prescribed temperature;
applying the adhesive agent to a prescribed part of the plate heated at the prescribed temperature;
mounting the works onto the heated and melted adhesive agent;
moving each of the pressing heads toward the press table so as to press the one work onto the plate, for a prescribed time, at the constant pressure;
adhering the works on the plate by cooling and solidifying the adhesive agent in the state where the works are pressed by the pressing heads; and
moving each of the pressing heads away from the press table so as to take out the plate, on which the works have been adhered, from the press table.

3. A method for adhering works in a work adhering apparatus comprising:
a press table including a heating mechanism and a cooling mechanism; and
a plurality of pressing heads being provided above the press table and capable of independently moving close to and away from the press table,
wherein the press table and the pressing heads press and adhere the works onto a plate with an adhesive agent,
said method comprising the steps of:
conveying the plate, which has been heated at a prescribed temperature, to the press table, or heating the plate on the press table until reaching the prescribed temperature;
applying the adhesive agent to a prescribed part of the plate heated at the prescribed temperature;
mounting the works onto the heated and melted adhesive agent;
heating the pressing heads until reaching the prescribed temperature;
moving each of the pressing heads toward the press table so as to press the one work onto the plate, for a prescribed time, at the constant pressure;
adhering the works on the plate by cooling the press table and the plate with the cooling mechanism and solidifying the adhesive agent in the state where the works are pressed by the pressing heads; and
moving each of the pressing heads away from the press table so as to take out the plate, on which the works have been adhered, from the press table.

4. The method according to claim 3,
wherein, in the step of adhering the works, temperatures of the pressing heads are detected, and
the pressing action of the pressing head is stopped after the temperature of the pressing head lower than the prescribed temperature is confirmed.

5. The method according to claim 3,
wherein the plate is previously heated on a heating table, which includes a heater and which is separated from the press table, and
the heated plate is conveyed onto the press table.

6. The method according to claim 3,
wherein the pressing heads are brought into contact with the press table so as to heat the pressing heads until reaching the prescribed temperature.

7. The method according to claim 3,
wherein each of the pressing heads is heated, until reaching the prescribed temperature, by a built-in heater.

8. The method according to claim 3,
wherein each of the pressing heads is rotatable about a ball bearing, and
each of the pressing heads is rotated to follow the surface of the plate so as to press the work.

9. The method according to claim 3,
wherein sapphire substrates, on each of which a nitride semiconductor layer is formed, are adhered onto the plate, as the works, in a state where the nitride semiconductor layers face the plate.

10. A work adhering apparatus,
comprising:
a press table; and
a plurality of pressing heads being provided above the press table and capable of independently moving close to and away from the press table,
wherein the press table and the pressing heads press and adhere the works onto a plate with an adhesive agent, and
each of the pressing heads presses the one work onto the plate at a constant pressure.

11. The work adhering apparatus according to claim 10,
wherein the pressing heads are connected to a common air supply source.

12. The work adhering apparatus according to claim 10,
wherein the press table includes a heating mechanism and a cooling mechanism, and
the press table and the pressing heads are heated, the works are pressed onto the adhesive agent applied on the plate to spread the adhesive agent, then the press table and the plate are cooled, by the cooling mechanism, so as to solidify the adhesive agent and adhere the works on the plate.

13. The work adhering apparatus according to claim 12,
further comprising a temperature detecting section for detecting temperatures of the pressing heads,
wherein the temperature detecting section detects temperatures of the pressing heads while cooling the press table to solidify the adhesive agent, and
the pressing action of the pressing head is stopped after the temperature of the pressing head lower than a prescribed temperature is confirmed.

14. The work adhering apparatus according to claim 13,
wherein the temperature detecting section detects a temperature of a part of each of the pressing heads located close to a pressing face for pressing the work.

15. The work adhering apparatus according to claim 12,
wherein the pressing heads are brought into contact with the press table so as to heat the pressing heads until reaching the prescribed temperature.

16. The work adhering apparatus according to claim 12,
wherein each of the pressing heads includes a heating mechanism and a cooling mechanism.

17. The work adhering apparatus according to claim 12,
further comprising a heating table including a heater, the heating table being separated from the press table,
wherein the plate is previously heated on the heating table, and then the heated plate is conveyed onto the press table.

18. The work adhering apparatus according to claim 12,
wherein the cooling mechanism is embedded in a part of the press table, which is located close to the surface on which the plate is mounted.

19. The work adhering apparatus according to claim 17,
further comprising a temperature detecting section for detecting a temperature of the plate which has been mounted on the heating table.

20. The work adhering apparatus according to claim 17,
further comprising a temperature detecting section for detecting temperatures of the press table and the heating table.
